(19) United States
(12) Patent Application Publication
(10) Pub. No.: US 2024/0368398 A1
(43) Pub. Date: Nov. 7, 2024

(54) BIODEGRADABLE COMPONENTS

(71) Applicant: BONDON INTERNATIONAL, Lancashire (GB)

(72) Inventors: David REARDON, Lancashire (GB); Andrew George BOND, Lancashire (GB)

(21) Appl. No.: 18/291,590

(22) PCT Filed: Jul. 28, 2022
(86) PCT No.: PCT/GB2022/051987

§ 371 Date: Jan. 24, 2024

(30) Foreign Application Priority Data
Jul. 28, 2021 (GB) 2110859.2

(51) Int. Cl. C08L 67/04; C08K 3/26

(52) U.S. Cl. CPC C08L 67/04; C08K 3/26; C08K 2003/265; C08L 2201/06

(57) ABSTRACT

The present invention relates to an injection moulded biodegradable component comprising: a) 60 to 99 wt % of a biodegradable film-grade bioplastic; and b) 0 to 40 wt % of filler comprising a biodegradable polymer and a non-toxic 5 mineral; and methods for producing said component.

### FIELD OF THE INVENTION

The present invention relates to a variety of fully biodegradable components, in particular an ammunition component.

### BACKGROUND OF THE INVENTION

The use of ammunition components made of non-biodegradable plastics presents important ecological problems, as the natural soil is littered with components, such as wads. It is in this action of dumping non-biodegradable plastics in nature, without recycling them in any way, wherein environmental contamination occurs, since both the discarded components will remain in the soil for centuries before degrading. For example, environmental contamination can occur after firing a gunshot which expels the cartridge from the weapon and remains on the ground, along with the container wad, since it is projected far way after the gunshot and is also scattered on the ground.

Currently, the most used plastic is high-density polyethylene, which may take a long time to disappear from the environment. This is why currently hunting associations and shooting ranges demand a biodegradable cartridge, which also fulfils the proper functions for the development of these sports and activities. Said organic material must meet the technical specifications for use in cartridges, for example, they must have sufficient density and strength for their intended use while the materials that make up the mixture cannot contain any heavy metals or toxic elements.

Patent application EP3290858 attempts to address this issue by formulating a shotgun cartridge manufactured from a bioplastic comprised of biodegradable polymers of vegetable origin, such as 60% of polylactic acid (PLA), plus 39% of a biodegradable elastomeric polymer and 1% of a calcium carbonate mineral filler by injection moulding. PLA is a hard and brittle material, as such, it can be injection moulded into a desired shape easily. However, it does not have elastomeric properties, therefore it does not biodegrade as well as film-grade bioplastics. Film-grade bioplastics have the desired elasticity and extremely quick degradation time for a biodegradable ammunition component, however, they are not suitable for injection moulding, due to their melt flow rate and tensile strength, which makes them incredibly difficult to manufacture an ammunition component with.

Therefore there is a need in the art to provide an ammunition component that is manufactured from film-grade bioplastics to maximise biodegradability whilst at the same time can be easily manufactured.

### SUMMARY OF THE INVENTION

The present inventors have solved the problems of the prior art and created a method to manufacture a biodegradable ammunition component utilising film-grade bioplastics and injection moulding. As such, the manufactured biodegradable ammunition component is easy and efficient to manufacture and has the desired properties that allow for quick biodegrading, such as in water. Further, unlike many materials used in injection moulding, the combination of materials used in the present invention do not shrink whilst setting during the injection moulding so the biodegradable component produced matches the size of the mould's cavity. The material stays stable such that the size does not alter significantly after moulding by either the absorption or loss of water, unlike PVOH which will alter depending on the humidity.

Accordingly, in a first aspect of the present invention, there is provided an injection moulded biodegradable component comprising:
a) 60 to 99 wt % of a biodegradable film-grade bioplastic; and
b) 0 to 40 wt % of filler comprising a biodegradable polymer and a non-toxic mineral.

Accordingly, in a second aspect of the present invention, there is provided a process of manufacturing an injection moulded biodegradable component comprising the steps:
a) heating and mixing together a biodegradable film-grade bioplastic and a filler comprising a biodegradable polymer and a non-toxic mineral;
b) forming the injection moulded biodegradable component by injection moulding.

Accordingly, in a third aspect of the present invention, there is provided an injection moulded biodegradable component formed by the process of the second aspect.

### BRIEF DESCRIPTION OF THE FIGURES

FIG. 1 shows a drawing of the shotgun wad from example 1.

FIG. 2 shows a drawing of a gas seal that can be made by the process of the invention.

FIGS. 3A and 3B show a drawing of a shotgun wad with pins in the base that can be made by the process of the invention.

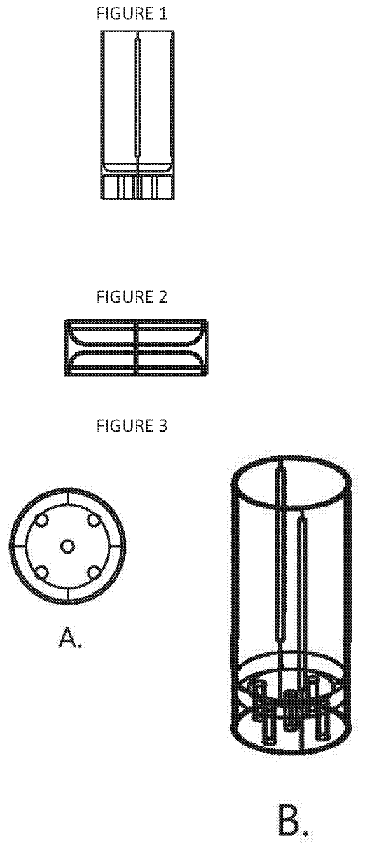

### DETAILED DESCRIPTION OF THE INVENTION

Unless indicated otherwise, all technical and scientific terms used herein will have their common meaning as understood by one of ordinary skill in the art to which this invention pertains.

As used herein, the term “comprises” will take its usual meaning in the art, namely indicating that the component includes but is not limited to the relevant features (i.e., including, among other things). As such, the term “comprises” will include references to the component consisting essentially of the relevant features. As used herein, the term “consists essentially of” will refer to the relevant component being formed of at least 80% (e.g., at least 85%, at least 90%, or at least 95%, such as at least 99%) of the relevant features, according to the relevant measure (e.g., by weight thereof).

“wt %” is a common abbreviation in the art to mean the “weight %” with respect to the total weight of the article/material referred to.

A biodegradable bioplastic is a plastic material produced from renewable biomass sources, such as vegetable fats and oils, corn starch, straw, woodchips, sawdust, recycled food waste. Bioplastics can be made from agricultural by-products and also from used plastics by using microorganisms. The bioplastics used in the present invention are biodegradable and compostable according to the European standard UNI EN 13432, which is often considered the most important reference for the technical material manufacturers, public authorities, composters, certifiers and consumers.

Suitably the biodegradable film-grade bioplastic used in the present invention may be of oil, and/or vegetable and/or starch origin (for example, corn starch). Preferably the biodegradable film-grade bioplastic comprises corn starch. In one preferred embodiment the biodegradable film-grade bioplastic is engineered from a combination of plant and non-plant origin, such as the biodegradable film-grade bioplastic comprises starch and cellulose acetate blends.

Preferably the biodegradable film-grade bioplastic is a polyester.

Importantly, the bioplastics used in the present invention are film-grade. By “film-grade” we mean a material that is typically processed by the well-known “blown film extrusion”. Blown film extrusion is a process that involves extruding a tube of molten polymer through a die and inflating to several times its initial diameter to form a thin film bubble. This bubble is then collapsed and used as a lay-flat film. A downside to blown film extrusion is that it can only produce sheets or tubes. “Film-grade bioplastics” cannot be injection moulded due to their low melt rate and tensile strength, resulting in their stickiness and thinness, furthermore they degrade too quickly making them unworkable in this process. Another property of the film-grade bioplastic is that it is elastomeric which gives it great elasticity and flexibility.

Suitably the injection moulded biodegradable component comprises 65 to 99 wt % of a biodegradable film-grade bioplastic, preferably 70 to 99 wt %, more preferably 75 to 99 wt %, such as 80 to 99 wt % of a biodegradable film-grade bioplastic.

Tensile strength is a measurement of the maximum load that a material can support without fracture when being stretched, divided by the original cross-sectional area of the material. Suitably, the biodegradable film-grade bioplastic may have a tensile strength between 10 and 60 MPa, preferably between 15 and 50 MPa, more preferably 20 and 40 MPa. The tensile strength is recorded according to ISO 527-3 method, which is a common international standard that is used to determine the tensile properties of plastic film or sheeting—the test film or sheeting has a thickness of less than 1 mm.

A melt flow test measures the melt flow rate (MFR) and melt volume rate (MVR) of a molten polymer. Values are taken at a certain temperature and with a certain mass applied, dependent on material. The test system consists of: A heated barrel with a removable die at one end. Suitably, the biodegradable film-grade bioplastic may have a melt flow rate between 0.5 and 10 g/10 min, preferably 1 and 9 g/10 min, more preferably 1.5 to 8 g/10 min, yet more preferably 2 to 7 g/10 min, even more preferably 2.5 to 6 g/10 min, such as 3 to 5 g/10 min, preferably 3 to 4 g/10 min, for example 3.5 g/10 min. The melt flow rate is recorded according to method ASTM D1238. This is a standard test method for measuring the melt flow rate of plastic materials.

Suitably the biodegradable film-grade bioplastic may have a melting temperature of between 85 and 150° C., preferably between 95 and 145° C., more preferably between 105 and 125° C., even more preferably between 110 and 120° C., such as about 115° C. The melting temperature is recorded according to method ASTM 3418. This is a standard test method for measuring the melting temperature of plastic materials.

Suitably in one aspect, the biodegradable film-grade bioplastic may have a melt flow rate between 3 to 5 g/10 min and a melting temperature of between 110 and 120° C.

The biodegradable component of the present invention is manufactured by injection moulding, which is a well-known manufacturing process for producing parts by injecting molten material into a mould. Briefly, material for the part is fed into a heated barrel, mixed (using a helical screw), and injected into a mould cavity, where it cools and hardens to the configuration of the cavity. Injection moulding is advantageous because it is precise and can thus make intricate parts, such as ammunition components. Furthermore, it has high repeatability, it is fast and is economical.

The inventors have found that by mixing the filler described herein with the biodegradable film-grade bioplastic, the tensile strength of the bioplastic is increased and the adhesive quality is decreased, which enables it to be injection moulded. The filler increases the ability for the bioplastic to cool and appears to stabilise the running, which helps the moulding process. The filler comprises a non-toxic mineral and a biodegradable polymer. The mineral is the component important for increasing the tensile strength of the bioplastic, by altering the melt flow rate of the bioplastic to allow the removal of heat quicker. The mineral also helps with the processability and results in a material with a higher impact strength. The biodegradable polymer functions as a carrier of the mineral.

Suitably the non-toxic mineral is a carbonate or salt, suitably an alkali metal or alkali earth metal carbonate or salt, preferably an alkali earth metal carbonate or salt. Preferable alkali metals are sodium, potassium or lithium. Preferable alkali earth metals are calcium or magnesium. Preferably the non-toxic mineral is a carbonate. Preferably the non-toxic mineral is calcium carbonate.

Suitably the biodegradable polymer in the filler is a thermoplastic polymer. “Thermoplastic polymer” are commonly known in the art and refer to a plastic polymer material that becomes pliable or mouldable at a certain elevated temperature and solidifies upon cooling. Suitably the thermoplastic polymer is a polyester, such as but not limited to polylactic acid (PLA) and/or a Polyhydroxyalkanoate. Suitably the Polyhydroxyalkanoate is Polyhydroxybutyrate (PHB), poly-4-hydroxybutyrate (P4HB), polyhydroxyvalerate (PHV), polyhydroxyhexanoate (PHH), polyhydroxyoctanoate (PHO) or copolymers thereof. Preferably the biodegradable polymer in the filler is PLA. PLA is derived from renewable resources like corn starch or sugar cane. Dependent on the formulation, a filler is not always required.

The injection moulded biodegradable component may comprise varying amounts of filler dependent on the desired properties of the ammunition component. Suitably the injection moulded biodegradable component may comprise 0 to 40 wt %, preferably 1 to 40 wt % filler, preferably 3 to 38 wt % filler, more preferably 5 to 35 wt % filler, yet more preferably 8 to 33 wt % filler, preferably 10 to 30 wt % filler, more preferably 15 to 25 wt % filler.

In a more specific aspect, the injection moulded biodegradable component may comprise 1 to 20 wt % filler, preferably 1 to 15 wt % filler, preferably 1 to 10 wt % filler, more preferably 1 to 5 wt % filler. Alternatively, the injection moulded biodegradable component may comprise 5 to 15 wt % filler, such as about 10 wt % filler.

In a more specific aspect, the injection moulded biodegradable component may comprise more than 1% filler, preferably more than 2 wt %, 3 wt %, 4 wt %, 5 wt %, 6 wt %, 7 wt %, 8 wt %, 9 wt % or 10 wt % filler and/or comprise less than 20 wt % filler, 19 wt %, 18 wt %, 17 wt %, 16 wt %, 15 wt %, 14 wt %, 13 wt %, 12 wt %, or 11 wt % filler. For the avoidance of doubt, any of the aforementioned lower range end-points may be combined with any of the aforementioned upper range end-points.

To further modify the properties of the ammunition component as desired, the amount of non-toxic mineral in the filler may be varied. Suitably the filler comprises less than 85 wt % of the non-toxic mineral, preferably less than 80 wt %, more preferably less than 75 wt % and/or the filler comprises more than 45 wt % of the non-toxic mineral, preferably more than 50 wt %, more preferably more than 55 wt %, even more preferably more than 60 wt %. For the avoidance of doubt, any of the aforementioned lower range end-points may be combined with any of the aforementioned upper range end-points.

Suitably the filler comprises less than 50 wt % of the biodegradable polymer, preferably less than 45 wt %, more preferably less than 40 wt % and/or the filler comprises more than 15 wt % of the biodegradable polymer, preferably more than 20 wt %, more preferably more than 25 wt %, even more preferably more than 30 wt %. For the avoidance of doubt, any of the aforementioned lower range end-points may be combined with any of the aforementioned upper range end-points.

The properties of the injection moulded biodegradable component may be further modified by the addition of an elastomeric polymer. Elastomeric polymers are lightly cross-linked and amorphous with a glass transition temperature well below room temperature and thus characterized by their great elasticity and ability to stretch and rebound, flexibility, and recovering their original shape once the force that deformed them is removed. Elastomeric polymers degrade extremely quickly and are soil compostable at standard environment temperatures.

Thus, suitably the injection moulded biodegradable component may further comprise at least one elastomeric polymer. Suitable elastomeric polymers include, but are not limited to, butyl rubber (polyisobutylene), polysiloxanes (silicone rubber), polyurethane (spandex), and fluoro-elastomers, perfluoroelastomers, polyisoprene, polybutadiene, and polychloroprene, styrene and isoprene (SIS) and styrene and butadiene (SBS) block copolymers, polyacrylic rubber, ethylene propylene rubber, polyether block amides, chlorosulfonated polyethylene and ethylene-vinyl acetate.

Suitably the injection moulded biodegradable component comprises at least 1 wt % of the at least one elastomeric polymer, preferably at least 3 wt %, more preferably at least 5 wt %, such as at least 10 wt %, for example at least 15 wt %.

Suitably the biodegradable film-grade bioplastic has an elongation at break value between 250 and 500%, preferably between 300 and 470%, more preferably between 390 and 450%. Elongation at Break measures how much bending and shaping a material can withstand without breaking. The measured elongation at break values are an indication of the ductility of a polymer. The elongation at break value is recorded according to ISO 527-3 method, which is a common international standard that is used to determine the tensile properties of plastic film or sheeting—the test film or sheeting has a thickness of less than 1 mm.

Suitably the biodegradable film-grade bioplastic has a young modulus value between 100 and 300 MPa, preferably between 200 and 300 MPa, more preferably between 225 and 275 MPa. Young's modulus is a measure of the ability of a material to withstand changes in length when under lengthwise tension or compression. The young modulus value is recorded according to ISO 527-3 method, which is a common international standard that is used to determine the tensile properties of plastic film or sheeting—the test film or sheeting has a thickness of less than 1 mm.

Suitably the biodegradable film-grade bioplastic has an elongation at break value between 390 and 450% and a young modulus value between 225 and 275 MPa and optionally a density between 1.23 and 1.29 g/cm³.

Suitably the biodegradable film-grade bioplastic has a density between 1.0 and 1.5 g/cm³, preferably between 1.15 and 1.35 g/cm³, most preferably between 1.2 and 1.3 g/cm³ such as between 1.23 and 1.29 g/cm³. Density is the mass per unit volume of any object. The density is recorded according to the ASTM D792 method. This standard test method allows for measurement of the density and specific gravity of plastic materials by the buoyancy in a liquid, such as water.

Suitably, the biodegradable film-grade bioplastic may have a melt flow rate between 3 to 5 g/10 min, a melting temperature of between 11° and 120° C., an elongation at break value between 390 and 450% and a young modulus value between 225 and 275 MPa and optionally a density between 1.23 and 1.29 g/cm³.

Suitably the filler has a density between 1.7 and 2.3 g/ml, preferably between 1.75 and 2.1 g/ml, more preferably between 1.8 and 2.0 g/ml. The density of the filler was recorded according to the ISO 1133 method.

Suitably the filler has a melt flow rate between 0.9 and 1.5 g/10 min, preferably between 1.0 and 1.4 g/10 min, most preferably between 1.1 and 1.3 g/10 min.

Suitably the ratio of the biodegradable film-grade bioplastic to the filler is between 12:1 and 3:2, preferably between 9:1 and 3:2. In one aspect the ratio of the biodegradable film-grade bioplastic to the filler is between 4:1 and 3:2, such as about 7:3. Alternatively, the ratio of the biodegradable film-grade bioplastic to the filler is between 12:1 and 6:1, such as about 9:1.

The injection moulded biodegradable component can take many forms by using a suitably shaped mould. The resultant product is more flexible and impact resistant versus traditional components predominately made of materials such as PLA. Suitably the component is an ammunition component is a wad, sabot, obturator, gas seal, or a shell case, preferably a wad.

Suitably the weight of the injection moulded biodegradable component is between 0.3 g and 10 g, preferably between 0.5 g and 8 g, more preferably between 0.7 g to 5 g, yet more preferably between 0.8 g and 4 g, such as between 0.9 g and 3.5 g.

Suitably the density of the injection moulded biodegradable component is low to ensure it has a good performance when used in applications such as ammunition components, particularly a wad. Suitably the density of the injection moulded biodegradable component is 0.2 to 10 g/cm³, preferably 0.3 to 5 g/cm³, more preferably 0.4 to 3 g/cm³, most preferably 0.5 to 2 g/cm³.

In the second and third aspects of the invention, the process and the injection moulded biodegradable component formed by the process may have any of the features described above for the first aspect. For the avoidance of doubt, the steps (a) to (b) in the second aspect of the invention are carried out in the stated order.

The biodegradable film-grade bioplastic and the filler are typically supplied in pelletised form, hence, heat is required in step a) of the process to melt and mix them together. Suitably the heating is to less than 210° C., preferably less than 200° C., more preferably less than 190° C., most preferably less than 185° C. and/or the heating is to more than 140° C., preferably to more than 150° C., more preferably to more than 160° C., most preferably to more than 170° C. For the avoidance of doubt, any of the aforementioned lower range end-points may be combined with any of the aforementioned upper range end-points.

As the skilled person would understand, the heating and mixing is a continuous process within the barrel of the injection moulding machine. However, as the material is heat sensitive it is important not to allow it to degrade due to being heated for too long or allowed to go over a set temperature. To facilitate this the barrel size of the machine/extruder is calculated/selected to give the least latent heat time in the barrel. The exact size and timings will depend on the weight of the total number of items made at one time in the associated mould tool or shot size. Similarly, the temperature in the barrel or extruder must be set and maintained at the required temperature to allow the process to function.

As part of the injection moulding process, it is common knowledge that an injection pin is used to inject the melted and mixed materials into the mould. Suitably the ejection pin has a diameter between 5 and 25 mm, preferably between 10 and 20 mm, preferably between 15 and 20 mm, such as about 10.3 mm, 13.8 mm, 15.7 mm, or 16.9 mm. It will be known by the skilled person that the injection pin diameter can be altered dependent on the component being manufactured, as mechanical pressure moving the materials should be spread as evenly as possible across the surface and will be designed to match the component being made. For example, for a 12 gauge shotgun cartridge 18.5 mm is the optimum.

Suitably the mould is in the shape of an ammunition component is a wad, sabot, obturator, gas seal, or a shell case, preferably a wad.

Suitably after step b), the method further comprises step c) of removing the injection moulded biodegradable component from the mould.

It is recognised in the application that the material properties of film-grade bioplastics can cause issues in manufacturing components using injection moulding. However, there are possible mechanical changes that can be made to the traditional injection moulding method that can allow changes to the amount of filler, suitably the filler may not be required. For example, using particular materials in the barrel of the injection moulding machine, shaping appropriately the component, using air Ejection, moveable plates or cores, apply surface finishes such as non-stick surfaces to the mould tool and changing the size of the Ejection pins particularly to fit with the component size. As such there is also provided an injection moulded biodegradable component comprising 100 wt % of a biodegradable film-grade bioplastic. There is also provided a method of making an injection moulded biodegradable component comprising 100 wt % of a biodegradable film-grade bioplastic using any of the steps/processes listed above.

### EXAMPLES

### Example 1—A Process of Manufacturing an Injection Moulded Biodegradable Shotgun Wad

### Materials.

The biodegradable film-grade bioplastic was obtained from Novamont, it had the tradename “Mater-Bi for mulching”, and is designed to be used as compostable film for use in agriculture as a mulching film or for domestic use in food waste bags and compostable bags. It has compostability certification according to standard UNI EN 13432 and is made from corn starch and cellulose acetate. It has a tensile strength of 20-40 MPa, elongation at break of 250-500%, Young modulus of 100-300 MPa, density of 1.23 to 1.29 g/cm³, and MFR of 3 to 7 g/10 min.
The filler was obtained from GCR Group, it had the tradename “Biogranic 3112” and comprises 67% calcium carbonate and 33% biodegradable thermoplastic resin with a density of 1.9 g/ml (ISO 1183) and a MFR (at 190° C./5 kg) of 1.2 g/10 min (ISO 1133).

### Method

1) The biodegradable film-grade bioplastic and the filler (at a weight ratio of 7:3 or 9:1) were heated to 185° C. and mixed together in the barrel (10.3 second cycle) of an injection moulding machine. The barrel consists of a metal barrel fitted with an integral screw system. The barrel has a number of heaters fitted around it to allow the barrel to be heated and thus melt the material inside. The injection moulding machine used the screw and barrel to force material into the mould by rotating the screw or auger. The material travels along the screw within the barrel arriving at the injection end in a molten state.
2) The melted and mixed materials are then injected into the wad-shaped mould.
3) The component is allowed to cool for a predetermined time to allow it to set, the mould is opened and the ejector rod of the injection moulding machine pushes the ejector plate of the mould to eject the formed biodegradable shotgun wad. It may also be ejected using air

The wads formed with both ratios used went through the manufacturing process successfully to form solid, biodegradable components that performed as required in a shotgun cartridge. Upon shooting the gun, the heat caused the biodegradable wad to start to degrade, i.e., the intense heat from the firing process started the decomposition process.

### Test of Compostability

Aim: to test the Compostability of the wad of Example 1 under various conditions described below. No additional heat was applied to any of the below conditions other than the natural ambient temperatures as is typical from January to July in England.

### Home Compost Bin

50 samples of the wad were placed in a standard home compost bin and left for around 6 months. The resultant examination after 6 months showed very little or no trace of the wads.

### Soil Compost

50 samples of the wad were submerged in soil in a pot. The pot was watered and left for 6 months. The pots were regularly examined, and it was found the products became brittle very quickly (after around 3 months) and had crumbled to nothing after about 6 months, I.e., there was no visible trace of the wad product material in the soil.

### Products Left Outside but not Submerged

50 samples of the wad were placed on top of soil in a pot and left. The wads broke down like the first two conditions albeit slightly slower—It took about 6 months to appear crumbly and brittle and then by 12 months there was very little or no trace of them.

Conclusion: the products of the invention naturally biodegrade in various natural environmental conditions within a quick timeframe (approximately 6-12 months).

1. An injection moulded biodegradable component comprising:
a) 60 to 99 wt % of a biodegradable film-grade bioplastic; and;
b) 0 to 40 wt % of filler comprising a biodegradable polymer and a non-toxic mineral.

2. The injection moulded biodegradable component of claim 1 wherein the biodegradable film-grade bioplastic has a tensile strength between 10 and 60 MPa, preferably between 15 and 50 MPa, more preferably 20 and 40 MPa.

3. The injection moulded biodegradable component of claim 1 wherein the biodegradable film-grade bioplastic has a melt flow rate between 0.5 and 10 g/10 min, preferably 1 and 9 g/10 min, more preferably 2 to 7 g/10 min, most preferably 2 to 5 g/10 min or the film-grade bioplastic has a melting temperature of between 85 and 150° C. preferably between 95 and 145° C., more preferably between 105 and 125° C.

4. (canceled)

5. The injection moulded biodegradable component of claim 1 wherein the biodegradable film-grade bioplastic is of oil, and/or vegetable and/or starch origin.

6. The injection moulded biodegradable component of claim 1 wherein the biodegradable film-grade bioplastic is a polyester.

7. The injection moulded biodegradable component of claim 1 further comprising at least one elastomeric polymer.

8. The injection moulded biodegradable component of claim 1 wherein the biodegradable film-grade bioplastic has an elongation at break value between 250 and 500%.

9. The injection moulded biodegradable component of claim 1 wherein the biodegradable film-grade bioplastic has a young modulus value between 100 and 300 MPa.

10. The injection moulded biodegradable component of claim 1 wherein the biodegradable film-grade bioplastic has a density between 1.0 and 1.5 g/cm³, preferably between 1.15 and 1.35 g/cm³, most preferably between 1.2 and 1.3 g/cm³ such as between 1.23 and 1.29 g/cm³.

11. The injection moulded biodegradable component of claim 1 comprising 5 to 35 wt % of filler, preferably 10 to 30 wt % of filler, more preferably 15 to 25 wt % of filler.

12. The injection moulded biodegradable component of claim 1 wherein the filler comprises less than 85 wt % of the non-toxic mineral, preferably less than 80 wt %, more preferably less than 75 wt %.

13. The injection moulded biodegradable component of claim 1 wherein the filler comprises more than 45 wt % of the non-toxic mineral, preferably more than 50 wt %, more preferably more than 55 wt %, even more preferably more than 60 wt %.

14. The injection moulded biodegradable component of claim 1 wherein the filler comprises less than 50 wt % of the biodegradable polymer, preferably less than 45 wt %, more preferably less than 40 wt %.

15. The injection moulded biodegradable component of claim 1 wherein the filler comprises more than 15 wt % of the biodegradable polymer, preferably more than 20 wt %, more preferably more than 25 wt %, even more preferably more than 30 wt %.

16. The injection moulded biodegradable component of claim 1 wherein the non-toxic mineral is a carbonate or salt, preferably an alkali earth metal carbonate or salt, such as calcium carbonate.

17. The injection moulded biodegradable component of claim 1 wherein the biodegradable polymer is a thermoplastic polymer, preferably a polyester, preferably selected from polylactic acid (PLA) and/or a Polyhydroxyalkanoate, preferably PLA.

18. The injection moulded biodegradable component of claim 1 wherein the filler has a density between 1.7 and 2.3 g/ml, preferably between 1.75 and 2.1 g/ml, more preferably between 1.8 and 2.0 g/ml.

19. The injection moulded biodegradable component of claim 1 wherein the filler has a melt flow rate between 0.9 and 1.5 g/10 min, preferably between 1.0 and 1.4 g/10 min, most preferably between 1.1 and 1.3 g/10 min.

20. The injection moulded biodegradable component of claim 1 wherein the component is an ammunition component, such as a wad, sabot, obturator, gas seal, or a shell case.

21. (canceled)

22. A process of manufacturing an injection moulded biodegradable component according to claim 1 comprising the steps:
a) heating and mixing together a biodegradable film-grade bioplastic and a filler comprising a biodegradable polymer and a non-toxic mineral;
b) forming the injection moulded biodegradable component by injection moulding.

23. (canceled)

24. (canceled)
